(19) United States
(12) Patent Application Publication
(10) Pub. No.: US 2026/0140651 A1
(43) Pub. Date: May 21, 2026

(54) DATA TRANSFERS AMONG PROCESSORS

(71) Applicant: Intel Corporation, Santa Clara, CA (US)

(72) Inventor: Cong ZHANG, Shanghai (CN)

(21) Appl. No.: 19/446,460

(22) Filed: Jan. 12, 2026

(30) Foreign Application Priority Data
Nov. 13, 2025 (WO) PCT/CN2025/134812

(51) Int. Cl. G06F 3/06; G06F 13/42

(52) U.S. Cl. CPC G06F 3/0647; G06F 3/0604; G06F 3/0673; G06F 13/4221; G06F 2213/0026

(57) ABSTRACT

Examples described herein relate to a memory and a processor, to execute instructions stored in the memory, to: share data between processors by: allocation of different memory-mapped Base Address Register (BAR) windows associated with an Non-Transparent Bridge (NTB) to different memory regions, copy data from the different memory regions to the different BAR windows, and copy data from the different BAR windows to destination memory regions. In some examples, the NTB is consistent with Peripheral Component Interconnect Express (PCIe) and the NTB communicatively couples root complexes of the processors.

### RELATED APPLICATION

This application claims the benefit of priority to PCT/CN2025/134812, filed Nov. 13, 2025. The entire contents of that application are incorporated by reference.

### BACKGROUND

Disaggregated large language model (LLM) inference is an architecture with two distinct phases of an LLM, namely, the prefill and the decode stages. In some cases, the prefill and the decode stages are separated and run on different hardware resources or computing instances. Prefill (prompt encoding) and decode (autoregressive generation) phases can be performed by different accelerators to improve utilization and admission control. In some deployments, prefill workers (P-workers) process a prompt and produce a per-layer Key/Value (KV) cache. Decode workers (D-workers) then reuse and append new-token KV entries while emitting output tokens.

### BRIEF DESCRIPTION OF THE DRAWINGS

FIG. 1A depicts an example system.

FIG. 1B depicts an example of operations.

FIG. 2 depicts an example of Non-Transparent Bridge (NTB) sliding-window data transfer.

FIG. 3 depicts an example dual sliding-window paging operations.

FIG. 4 depicts an example of flow control.

FIG. 5A depicts an example system.

FIG. 5B depicts an example system.

FIG. 6 depicts an example Process Address Space identifier (PASID)-scoped mapping states.

FIG. 7 depicts an example process.

FIG. 8 depicts a system.

### DETAILED DESCRIPTION

In multi-node topologies, P-workers and D-workers may be on adjacent hosts for scheduling flexibility and fault containment. On dual-socket servers, P-workers and D-worker graphics processing units (GPUs) can be coupled to different Peripheral Component Interconnect Express (PCIe) root complexes. In both cases, a KV cache is to be handed off post-prefill. During decode, incremental per-token KV updates may also traverse the same interconnect boundary. A PCIe Non-Transparent Bridge (NTB) allows multiple processors or systems on chip (SoCs) to communicate over a PCIe link to enable peer-to-peer communication, fault isolation, and high-bandwidth data exchange while maintaining independence of system memory, and operating system (OS). A PCIe NTB connects independent PCIe hierarchies while exposing memory-mapped apertures (e.g., Base Address Register (BAR) windows). BAR windows can be mapped to memory that support direct memory access (DMA) between devices on opposite sides of the NTB. Various examples provide shared memory regions across root complexes and alternate buffer writes and reads from the memory regions (e.g., BAR windows) while preserving multi-tenant memory isolation. Various examples can integrate NTB windows into accelerator runtime address spaces through external-memory interfaces.

Various examples can (i) stream data (e.g., KV tensors) through multiple fixed NTB memory-mapped BAR windows for access by a D GPU or other processor, (ii) utilize memory interfaces (e.g., Nvidia® CUDA, Advanced Micro Devices (AMD)® HIP, Intel® Level-Zero, or others) to access buffers and utilize direct memory access export and import semantics (e.g., Linux® dma-buf), and/or (iii) separate data of different tenants by utilizing Input-Output Memory Management Unit (IOMMU) features (e.g., Process Address Space identifier (PASID), Address Translation Service (ATS), and Page Request Interface (PRI)) and guard pages.

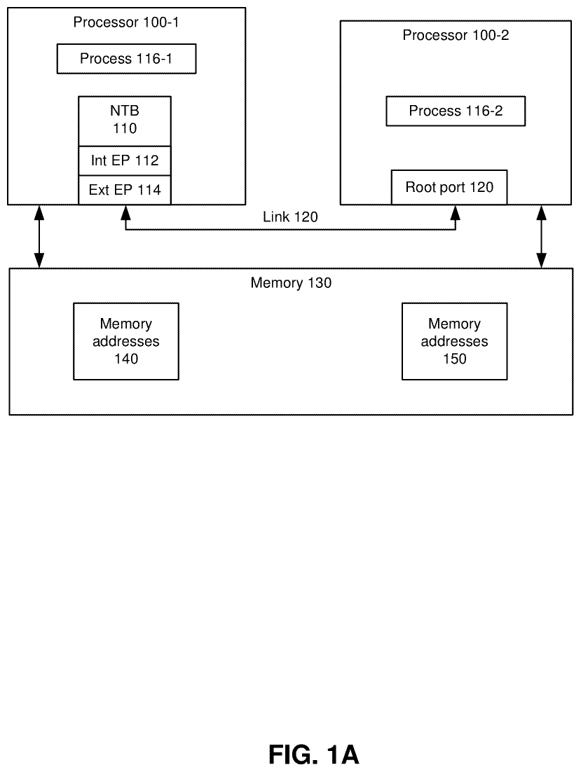

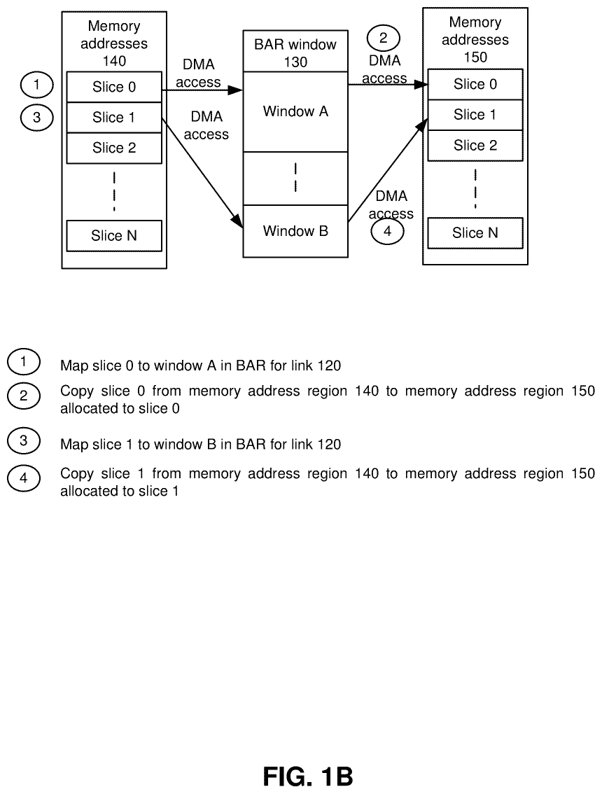

FIG. 1A depicts an example system. Processors 100-1 and 100-2 can include one or more of: an accelerator, central processing unit (CPU), graphics processing unit (GPU), core, or other processor. As described herein, processor 100-1 can perform operations of a P-GPU. Similarly, processor 100-2 can perform operations of a D-GPU. Conversely, processor 100-1 can perform operations of a D-GPU and processor 100-2 can perform operations of a P-GPU.

For processor 100-1, NTB 110 can include Pair of PCIe Endpoints where Internal (Int) side 112 includes a root complex integrated endpoint (RCiEP) and External (Ext) side 114 includes a PCI Express endpoint. NTB 110 of processor 100-1 can be attached to a Root Port (NTB-RP) or NTB attached to another NTB (NTB-NTB or “B2B”) of processor 100-2.

Memory address ranges 140 and 150 can include different memory address ranges in memory device 130. Memory address range 140 can be allocated to processor 100-1 (e.g., P GPU) whereas memory address range 150 can be allocated to processor 100-2 (e.g., D GPU). Link 120 can provide communicative coupling between PCIe NTB endpoints (e.g., processor 100-1 and 100-2) at least in accordance with Peripheral Component Interconnect express (PCIe) or Compute Express Link (CXL).

In some examples, PCIe NTB endpoints can copy data stored in a region of memory addresses 140 of memory 130 to a region of memory addresses 150 of memory 130 via NTB memory-mapped windows (e.g., 128-256 MB or other sizes) in a base address register (BAR) window associated with link 120, as described herein. For example, a P-GPU can write a slide N from memory address region 140 into window A of a BAR window 130 and P-GPU can write slide N+1 into window B of BAR window 130, with per-slide producer/consumer doorbells to indicate availability of data. A P-GPU can transmit Transaction Layer Packets to copy data for access by a D-GPU using link 120. When NTB is unavailable or has less available bandwidth than requested, the system can fall back to a network-based path (e.g., UCX RDMA or NCCL paths).

An operating system (OS) executed by processor 100-1 or 100-2 can enumerate NTB devices with at least two BAR windows designated for sharing of data between processors 100-1 and 100-2. A Linux kernel shim (e.g., nvntb_dma. ko) can map BAR windows and expose them as direct memory access (DMA) accessible regions (e.g., dma-buf-backed regions). A user-space library can reserve unified virtual address (UVA) ranges and import these ranges as DMA buffers through external memory interfaces to enable a processor to access memory (e.g., CUDA cuImportExternalMemory, HIP hipImportExternalMemory, and Level-Zero zeMemImportExternalPointer), producing device-visible pointers for both P-GPU and D-GPU.

For example, calling nvntb_dma. ko can map a slice 0 in memory address region 140 to a BAR window A and a DMA operation can copy data from slice 0 to memory address region 150. Similarly, calling nvntb_dma. ko can map a slice 1 in memory address region 140 to a BAR window B and a DMA operation can copy data from slice 1 to memory address region 150.

A kernel device node (e.g., /dev/nvntb_dma) can provide a process executed by a P-GPU or D-GPU with access to dma-buf file descriptors and PASID context identifiers. Memory import calls can resolve to pointers mapped to the NTB window address ranges.

Assigning a PASID to an independent KV transfer session and limiting accesses to memory according to PASIDs, guard pages, and Access Control Services (ACS) steering can provide security and multi-tenant isolation. The use of PASIDs can ensure isolation between different transfer sessions, even when they share the same physical NTB hardware.

For example, processors 100-1 and 100-2 can execute respective processes 116-1 and 116-2. Processes 116-1 and 116-2 can perform an inference engine (e.g., Virtual Large Language Model (vLLM), DeepSpeed) to write or read data (e.g., KV tensors) to a NTB window corresponding to a memory address range in a memory device 130 (e.g., dynamic random access memory (DRAM)) accessible to processors 100-1 and 100-2. At the start of a job, processes 116-1 and 116-2 can import the NTB windows as external memory. Processor 100-2 (e.g., D GPU) can receive device pointers devptr_windowA and devptr_windowB allocated to BAR windows. A call to Linux ioremap( ) can map guest physical addresses (GPA) in memory address regions 140 and 150 to windows in a BAR. An AI inference frame work orchestrator (e.g., vLLM or Deepseek) can call nvntb_dma. ko to map slices in memory address regions 140 and 150 to windows in a BAR.

The inference engine can access an allocator plugin that performs data transfers. The plugin can advertise a mode of data transfer (e.g., NTB, NTB and compression, or remote direct memory access (RDMA)). The inference engine can adapt data scheduling transfer based on an available mode of data transfer. The plugin can first attempt to obtain an NTB-backed device pointer to write or read data. But if NTB memory-mapped windows are unavailable or non-compliant with policy (e.g., insufficient window size or measured bandwidth below threshold), the plugin can utilize another protocol (e.g., Unified Communication X (UCX) Remote Direct Memory Access (RDMA), NVIDIA Collective Communication Library (NCCL)) or others be used for data transfer between root ports.

FIG. 1B depicts an example of operations. Calling nvntb_dma. ko can map slice 0 to window A, calling nvntb_dma. ko again can map slice 1 to window B, calling nvntb_dma. ko again can map slice 2 to window A, and so forth. At (1), a P GPU can copy Slice 0 in memory address region 140 to Window A of BAR window 130 by a DMA operation and the D GPU can receive a doorbell signal indicating that Slice 0 in memory address region 140 is ready in window A of BAR window 130. At (2), the D GPU can issue a copy kernel (e.g., DMA read operation) to retrieve the slice 0 from window A into memory address region 150 and write a Done doorbell back to indicate a copy has completed.

At (3), a P GPU can copy Slice 1 in memory address region 140 to Window B of BAR window 130 by a DMA operation and the D GPU receives a doorbell signal indicating that Slice 1 in memory address region 140 is ready in window B of BAR window 130. At (4), the D GPU can issue a copy kernel (e.g., DMA read operation) to retrieve the slice 1 from window B into memory address region 150 and write a Done doorbell back to indicate a copy has completed.

Thereafter, window A of BAR window 130 can be used to copy slice 2 from memory region 140 to memory region 150 and window B of BAR window 130 can be used to copy slice 3 from memory region 140 to memory region 150.

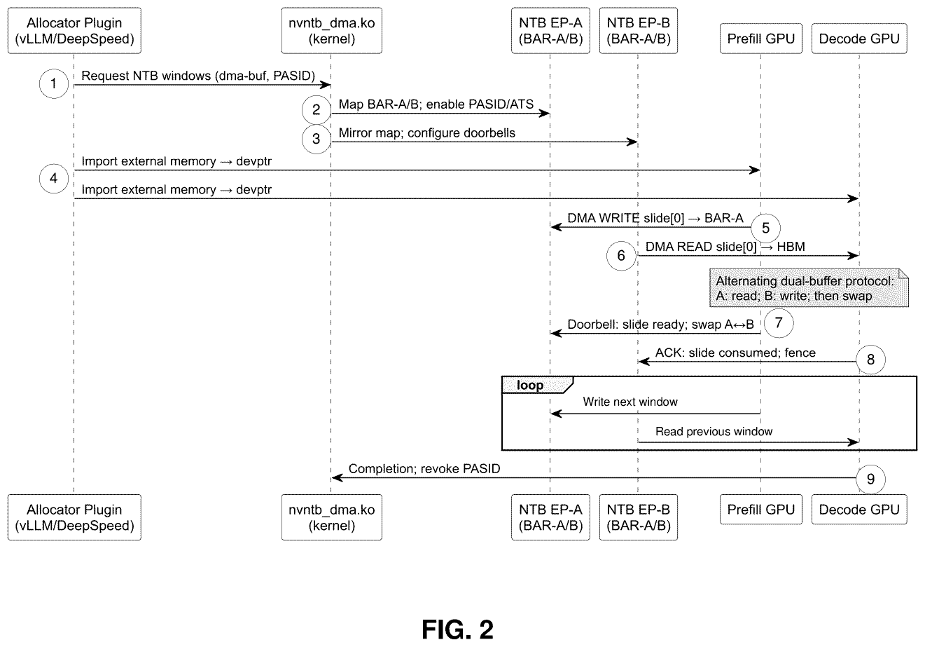

FIG. 2 depicts an example of NTB sliding-window data transfer. At (1), allocator plugin (e.g., vLLM or DeepSpeed) provides a framework entry point that requests buffers for data transfer (e.g., KV transfer), selects NTB for transport, and returns device pointers to P-GPU and D-GPU. The allocator plugin requests the kernel module for NTB windows. Kernel module maps the NTB BAR-A/B windows and mirrors the configuration on both endpoints. Kernel module creates a PASID-scoped IOMMU mapping with pages (e.g., 2 MiB or other sizes) and enables ATS and PRI, sets read, write, or read only (RW/RO) permissions, installs guard pages, and configures doorbells. Doorbell registers allow one hierarchy to send interrupts to the other. Kernel module exports the mapped region(s) as a dma-buf and returns a file descriptor and metadata.

At (2)-(4), the kernel module (e.g., nvntb_dma. ko) maps NTB BAR windows, enables PASID and IOMMU with ATS and PRI, installs guard pages and doorbells, and exports a DMA buffer (dma-buf) to user space for access by producer and consumer GPUs (e.g., prefill GPU and decode GPU). The user-space library imports the dma-buf into GPUs using external-memory application programming interfaces (APIs). A prefill GPU receives a device pointer with read/write access and the decode GPU receives a device pointer with read-only access. Hardware endpoints NTB Endpoint A and NTB Endpoint B allow access to two fixed memory-mapped windows (e.g., 128-256 MB in size or other sizes).

At (5), prefill GPU (producer) can issue a DMA write for data (e.g., KV slides) into the NTB windows. A KV slide can include KV entries or other data. KV data can include key and value vectors computed within the attention mechanism of transformer models. These entries are stored in a KV cache during the inference phase to speed up text generation by avoiding redundant computations.

At (6), decode GPU (consumer) can issue a DMA read to read the data (e.g., KV slides) from NTB windows into its memory (e.g., high bandwidth memory (HBM), cache, registers, or other volatile or non-volatile memory) and proceed to decode the KV slides. Under the dual-buffer sliding-window protocol, while the decode GPU is reading slide N from Window A, the Prefill GPU writes slide N+1 into Window B.

At (7), the producer writes a doorbell indicating readiness and the consumer acknowledges slide data consumption and then the roles of windows A and B swap whereby window A is written to and window B is read from. At (8), the decode GPU can issue an acknowledgement (ACK) that data was read. Operations can repeat so that a decode GPU reads a slide from a Window and the Prefill GPU writes another slide into another Window until the full KV cache has been transferred.

At (9), the decode GPU issues an indication of completion of reading the KV cache to the kernel module. The kernel module revokes the PASIDs assigned to the IOMMU mapping so that the NTB windows are not usable unless configured again.

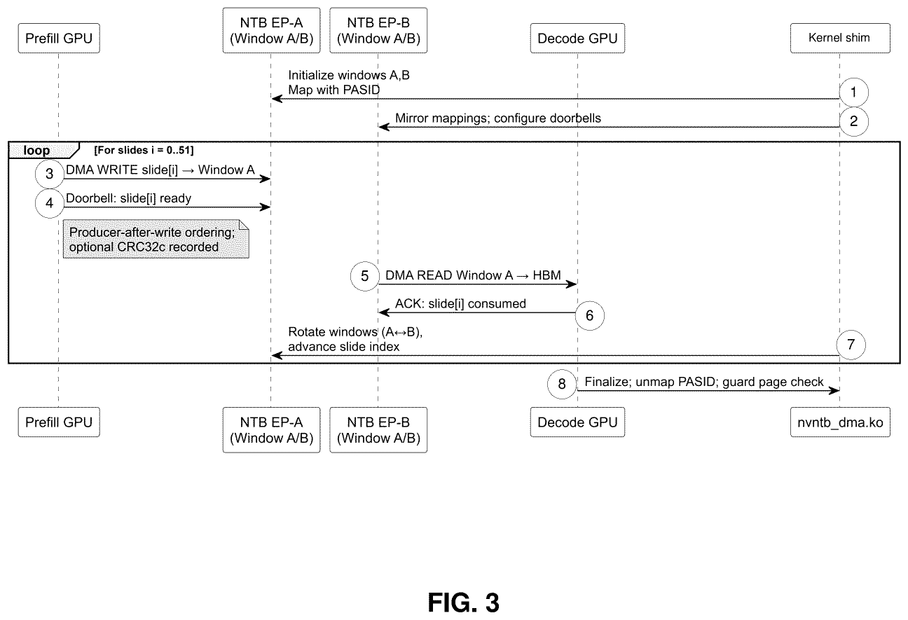

FIG. 3 depicts an example dual sliding-window paging operations. At (1) and (2), the kernel shim (e.g., nvntb_dma. ko) can initialize mappings of windows A and B on both endpoints and create PASID-scoped mappings with IOMMU pages, enable ATS/PRI, configure doorbells, and export these windows as a dma-buf to user space. For example, PASID can be assigned to an independent KV transfer session.

The kernel shim can export the NTB BAR windows as dma-buf file descriptors and exposes an ioctl to query window size, PASID association, and access attributes. A user-space library (libnvntb) reserves UVA ranges (e.g., via CUDA cuMemAddressReserve or equivalent mechanisms) and import dma-buf (e.g., using CUDA cuImportExternalMemory, HIP hipImportExternalMemory, or Level-Zero zeMemImportExternalPointer). The imported memory is then mapped to a device pointer (e.g., using CUDA cuExternalMemoryGetMappedBuffer or HIP hipExternalMemoryGetMappedBuffer). Access permissions are set to read/write for P-GPU and read-only for D-GPU to enforce least privilege.

At (3), the prefill GPU and decode GPU can perform a transfer loop to write and read data. Prefill GPU can provide a DMA WRITE slide[i] to Window A to NTB endpoint A (EP-A). At (4), prefill GPU can provide to NTB EP-A a producer doorbell “slide[i] ready” with producer-after-write ordering. Optionally, a producer prefill GPU records a slide-level integrity checksum (e.g., CRC32c).

At (5), NTB EP-B can read data from the decode GPU by a consumer DMA READ Window A into memory. At (6), decode GPU can provide to NTB EP-B with an ACK “slide[i] consumed,” with consumer-side fences. At (7), kernel shim can rotate windows (from A as written-to B as written-to and read from) between NTB EP-A and NTB EP-B, increment slide index, continue to a next iteration of writing and reading. Prefill GPU, as a producer, writes KV slides. NTB Endpoint A (NTBA) and NTB Endpoint B (NTBB) expose mirrored Windows A/B and doorbells/status registers and the decode GPU, as a consumer, reads slides into memory.

At (8), the decode GPU can issue a completion notification to kernel shim. Kernel shim can revoke PASID, unmap IOMMU, checks guard pages, and frees resources.

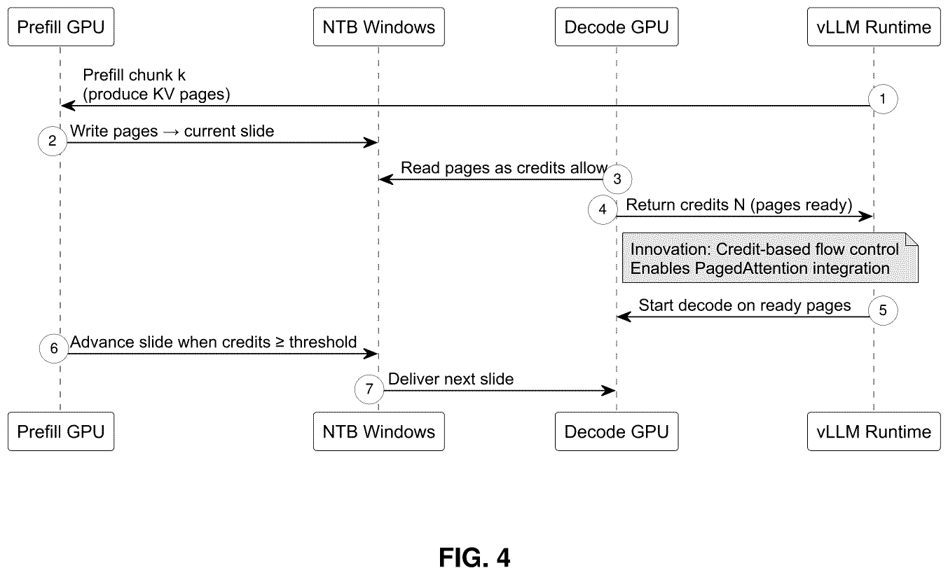

FIG. 4 depicts an example of page attention flow control. At (1), vLLM runtime instructs the prefill GPU to produce prefill chunk k, thereby generating KV pages (e.g., 16-64 KB tiles or other sizes). At (2), prefill GPU writes those pages into the current slide in the NTB window. At (3), consumer decode GPU reads pages as credits allow. At (4), when a threshold number of pages are ready, decode GPU returns credits N (pages ready) to vLLM runtime.

At (5), vLLM runtime decodes initialization on the ready pages, overlapping early decode with the continued arrival of later pages. At (6), when credits reach a configured threshold (e.g., a proportion of the slide's pages), the producer advances the slide index, and at (7), the alternating window protocol delivers the next slide. Operations (1) to (7) can repeat, allowing decode to progress while the transfer of later pages/slides is still underway.

A credit-based flow-control mechanism can integrate with vLLM's PagedAttention paging structure. A 256 MB slide can aggregate multiple PagedAttention pages (e.g., 16-64 KB tiles). The decode GPU can return credits when a threshold number of pages are ready, enabling the producer to advance the slide index without stalling decode. This permits decode initialization on early pages while later pages continue to arrive, reducing perceived latency. Credits, slide indices, and page counts can be maintained in a compact control block inside the NTB window, with monotonic counters and wrap handling to ensure robustness.

Telemetry can be collected per slide such as: data latency (e.g., time from producer doorbell to final acknowledgement (ACK)), control latency (window swap and remap duration), integrity status, and error counters. The allocator and kernel shim can expose these metrics through tracepoints and system file system (e.g., Liunx sysfs), enabling adaptive tuning, such as adjusting slide size, enabling/disabling compression, or modifying credit thresholds, to increase link occupancy and reduce Time to First Token (TTFT) variance.

When the prefill path emits KV in chunks, the flow-control layer maps these chunks to slides and credit thresholds, sustaining continuous transfer without large gaps. Under mixed workloads (varying prompt lengths), the credit scheme may prevent overrun of decode-side buffers while maintaining high NTB utilization.

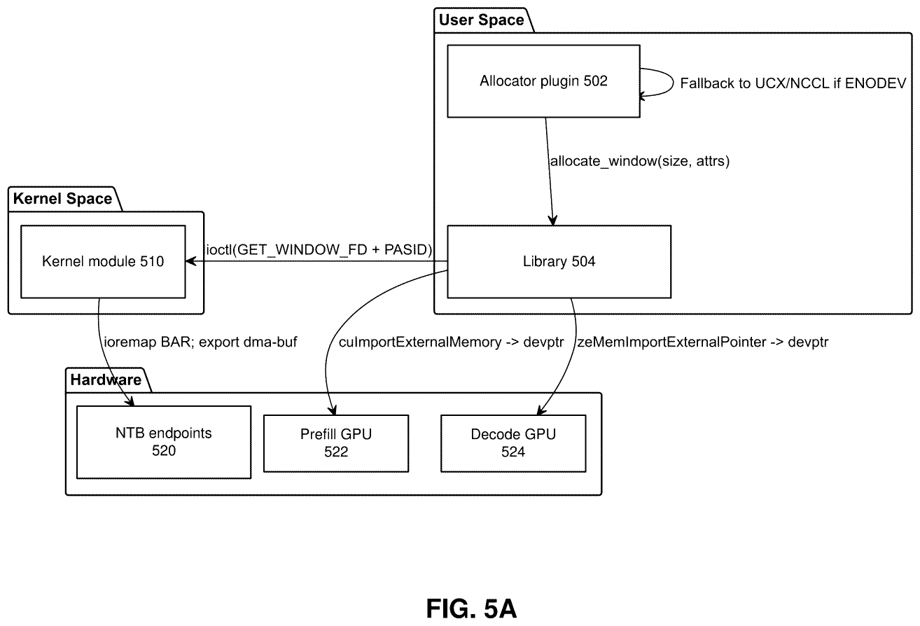

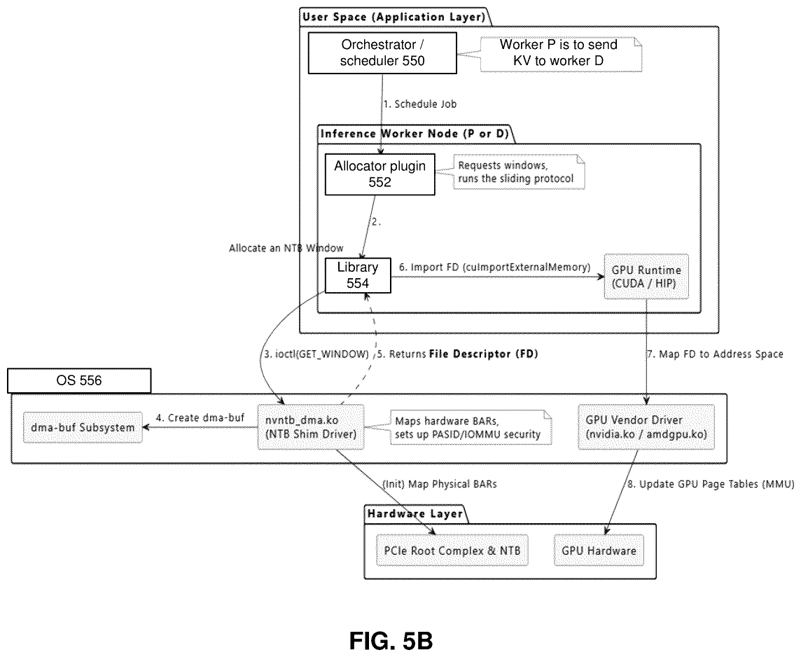

FIG. 5A depicts an example system. Allocator plugin 502 can be accessed by an inference framework to perform a KV transfer to a decode GPU. Allocator plugin 502 can choose a transport for the KV transfer with a preference for NTB preferred and RDMA/NCCL as a fallback based on availability of NTB. Based on availability of NTB, allocator plugin 502 can call library 504 (e.g., libnvntb) to allocate and map NTB windows. Allocator plugin 502 can return device pointers and a “mode token” (e.g., NTB, NTB+compression, RDMA).

Allocator plugin 502 can expose a single API that probes NTB availability and window size, executes a brief bandwidth warm-up test, and chooses among (i) NTB, (ii) NTB and compression, or (iii) RDMA/NCCL as a fallback. Compression (for example, FP8 or INT4 packing for KV tensors) is optional and can be applied when measured NTB bandwidth falls below a policy threshold (e.g., <50 GB/s) or when tenant preferences dictate reducing transfer volume. P-GPU can perform compression and D-GPU can perform decompression, using CUDA/HIP kernels with stream synchronization to overlap with control-plane activities.

User space library 504 (libnvntb) can provide the implementation of “allocate_window(size, attrs)”. User space library 504 can communicate with the kernel module via ioctl to obtain a dma-buf file descriptors (FD) and PASID-scoped mapping for the NTB windows. User space library 504 can reserve unified virtual address (UVA) space and import the dma-buf into GPU runtime(s) using external-memory APIs, producing device pointers. User space library 504 can set access permissions (e.g., Prefill GPU: read/write; Decode GPU: read-only).

Library 504 can validate size and alignment, handle partial-window mapping, and log integrity check failures with slide indices to facilitate root-cause analysis. Library 504 can provide explicit unmap routines that revoke PASID contexts and zero out guard pages to prevent stale access. After completion of KV transfer, user space library 504 can perform unmapping and teardown of windows and error propagation.

Kernel module 510 (e.g., nvntb_dma.ko) can pin and map the physical BAR apertures, program the NTB endpoint(s) (e.g., doorbell registers), and create the dma-buf export that represents the contiguous window(s) to user space. Kernel module 510 can provision the NTB BAR windows for user space by mapping the BARs, configuring PASID contexts in the IOMMU, enabling ATS/PRI, and exporting the region as DMA buffer (e.g., a dma-buf). Kernel module 510 can expose ioctls to create, query, or revoke windows (e.g., size, attributes, PASID, doorbell offsets). Kernel module 510 can install guard pages and enforce access attributes (e.g., read/write vs read-only).

NTB endpoints 520 can expose multiple fixed BAR windows (e.g., 128-256 MB each) that the kernel maps and exports and host doorbell and status MMIO registers. Prefill GPU (producer) and Decode GPU (consumer) are the endpoints that DMA to/from these windows using device pointers.

An example of operations can be as follows. Allocator plugin 502 can request user space library to allocate windows (e.g., allocate_window(size, attrs)). Allocator plugin 502 can request a buffer suitable for KV handoff with buffer attributes that can include size, desired slide size, and policy flags (e.g., compression allowed).

User space library 504 can issue to kernel module a request for windows (e.g., ioctl(GET_WINDOW_FD +PASID)). For example, libnvntb opens /ev/nvntb_dma and issues an ioctl to reserve and map two NTB BAR windows in the kernel, create a PASID-scoped IOMMU mapping of pages and ATS/PRI enabled, install guard pages and set access attributes, and export the mapped region(s) as a dma-buf FD and return metadata (e.g., sizes, offsets, capabilities).

Kernel module 510 (e.g., operating system) can issue to NTB endpoint 520 an ioremap BAR and export dma-buf. Kernel module 510 can pin and map the physical BAR apertures, program the NTB endpoint(s) (e.g., doorbell registers), and create the dma-buf export that represents the contiguous window(s) to user space.

User space library 504 can issue to prefill GPU to connect to memory. For example, cuImportExternalMemory is a function use to connect CUDA to memory allocated outside of CUDA and devptr can include a pointer (address) for passing memory addresses to kernels. libnvntb reserves UVA and imports the dma-buf FD using standard runtime calls (e.g., CUDA cuImportExternalMemory and cuExternalMemoryGetMappedBuffer; HIP and Level-Zero equivalents) to acquire a device pointer for prefill GPU 522 with read/write permissions.

User space library 504 can share memory to decode GPU 524 (e.g., Level Zero zeMemImportExternalPointer and devptr). The library repeats the import for the Decode GPU, but with read-only access, producing a consumer-side device pointer.

If the input output control (ioctl) or import fails (e.g., no NTB hardware, insufficient window size, missing features) or measured bandwidth is below a policy threshold, allocator plugin 502 can transparently fall back to network communications from interconnect communications (e.g., UCX RDMA or NCCL buffers). Allocator plugin 502 can return device pointers and a mode token.

For multi-tenant inference operations, isolation between jobs sharing physical infrastructure is utilized to protect data of different tenants. A layered isolation model can be utilized for NTB windows. For example, (i) a tenant can receive a distinct PASID context binding the NTB window to its GPU queue(s); (ii) IOMMU mappings use pages to reduce translation overhead and reduce the number of entries exposed; (iii) Address Translation Services (ATS) and Page Request Interface (PRI) keep device-side translation lookaside buffers (TLBs) synchronized and reduce IOTLB miss penalties; (iv) guard pages can be inserted at window boundaries to trap accidental overrun; (v) Access Control Services (ACS) on NTB endpoints can prevent request redirection or completion spoofing; and (vi) decode-side mappings can be set read-only to limit writable surfaces.

Based on allocator plugin 502 provisioning a window, kernel module 510 can create a PASID context, map the window with appropriate access rights, and return a dma-buf descriptor to user space. Upon slide completion and final ACK, the PASID mapping is revoked prior to reuse. If an overrun or integrity error is detected, a PASID unmapping and records an event containing the PASID, slide index, and error code to support forensic analysis.

FIG. 5B depicts an example system. At (1), orchestrator or scheduler 550 can determine a worker P GPU (e.g., worker P) that is to send data (e.g., KV) to a D GPU (e.g., worker D) and schedule a job with allocator plugin 552 for a P GPU to generate data and provide generated data to a D GPU. At (2), allocator plugin 552 can request windows among BAR windows for use to transfer data from a memory region allocated to a P GPU to a memory region allocated to a D GPU.

At (3), library 554 can issue to OS 556 a request for windows (e.g., ioctl(GET_WINDOW_FD +PASID)). At (4), a Linux kernel shim (e.g., nvntb_dma. ko) can map BAR windows and expose them as direct memory access (DMA) accessible regions (e.g., dma-buf-backed regions). At (5), OS 556 can return file descriptors (FD) and PASID-scoped mapping for the NTB windows. At (6), library 554 can provide a FD (e.g., CUDA cuImportExternalMemory, HIP hipImportExternalMemory, or Level-Zero zeMemImportExternalPointer) to produce device-visible pointers for both P-GPU and D-GPU. At (7), GPU runtime (e.g., CUDA or HIP) can map FD to address space to OS 556. At (8), OS 556 can update GPU page tables (MMU) for GPU hardware to provide BAR windows as buffers for data transfer from a P GPU to a D GPU.

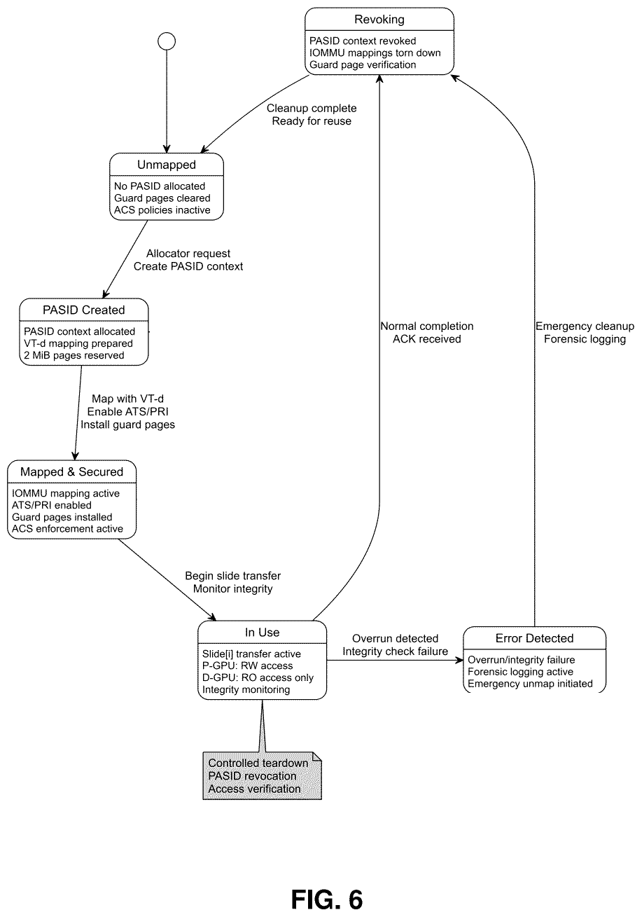

FIG. 6 depicts an example PASID-Scoped Mapping states. For the unmapped state, no PASID is allocated; guard pages are cleared; and ACS is not yet enforced. For PASID Created state, PASID context is allocated; VT-d mapping was prepared; and multiple pages are reserved. Transitioning from Unmapped to PASID Created can occur when allocator request triggers PASID allocation.

Transitioning from PASID Created to Mapped & Secured can occur to activate VT-d mappings, enable ATS/PRI, install guard pages and permissions. For Mapped & Secured state, IOMMU mapping is active; ATS/PRI is enabled; guard pages are installed; ACS is enforced; read only (RO) mapping is applied to the consumer.

Transitioning from Mapped & Secured to In Use can begin slide transfers and monitoring. For In Use state, slide transfer is in progress; producer has read write (RW) access; consumer has RO access; and integrity and overrun monitoring active.

Transitioning from In Use to Revoking can occur from completion after ACK; controlled teardown. For Revoking state, a PASID context is revoked; IOMMU mapping is torn down; guard pages are verified; resources are cleaned up; and the state returns to Unmapped.

Transitioning from In Use to Error Detected can occur on overrun or integrity failure and cause isolation and logging. For Error Detected state, overrun or integrity failure detected; forensic logging initiated; and emergency isolation path entered.

Transitioning from Error Detected to Revoking can involve an emergency cleanup path to perform forensic error logging.

Transitioning from Revoking to Unmapped can occur from completion of cleanup and a window is ready for reuse.

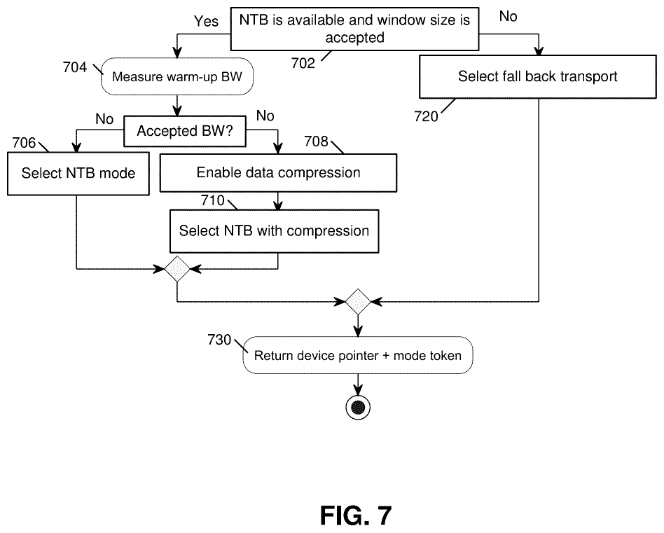

FIG. 7 depicts an example of transport selection. A user-space library or operating system (OS) can perform the process in some examples. At 702, an allocator can probe for NTB presence and BAR size and can verify whether the NTB is present and a window of a configured size is available. In some examples, the configured size is 128 MB, but other sizes can be configured. Based on the NTB is present and a window of a configured size is available, at 704, a bandwidth test can be performed to measure sustained throughput through the NTB and the window. At 706, if the NTB transmit bandwidth is above a configured accepted level, NTB mode can be selected and no compression on data can be performed. At 708, if the transmit bandwidth is less than a configured accepted level, compression can be enabled and at 710, NTB with compression can be selected for data transfer from a producer to consumer. Metrics collected during operation (e.g., sustained bandwidth, control-latency per slide, error rates) can be used to refine accepted bandwidth over time.

At 720, if NTB is absent or fails a health check, a fall back transport for data can be selected. For example, a network based communication using Ethernet packets (e.g., UCX RDMA or NCCL) can be selected as a fallback path. When NTB is absent or fails health checks, the system can allocate UCX RDMA buffers (or intra-node NCCL buffers) and route KV transfers through a configured fabric.

At 730, return device pointers and a mode token (e.g., NTB, NTB and compression, RDMA/NCCL) can be provided for logging and adaptive scheduling.

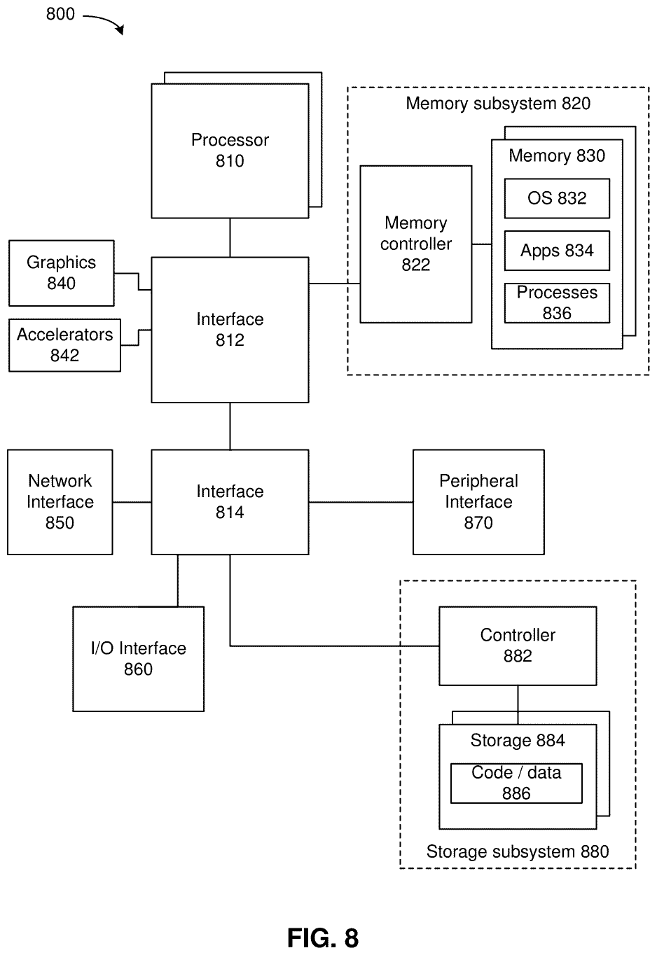

FIG. 8 depicts a system. In some examples, circuitry of system 800 can be utilized to share data among circuitry using BAR windows allocated to an NTB, as described herein. System 800 includes processor 810, which provides processing, operation management, and execution of instructions for system 800. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function field programmable gate arrays (FPGAs)). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Graphics interface 840 can provide an interface to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 800 includes one or more input/output (I/O) interface(s) 860. I/O interface 860 can include one or more interface components through which a user interacts with system 800. Peripheral interface 870 can include any hardware interface not specifically mentioned above. Peripherals refer generally to devices that connect dependently to system 800.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, version 1.0, was published on Mar. 1, 2011 (“NVMe specification”) or derivatives or variations thereof).

Communications between devices can take place using a network that provides die-to-die communications; chip-to-chip communications; circuit board-to-circuit board communications; and/or package-to-package communications.

In an example, system 800 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more later examples, and includes at least one computer-readable medium comprising instructions stored thereon, that if executed by at least one processor, cause the at least one processor to: share data between processors by: copy data from different memory regions to different Base Address Register (BAR) windows associated with a Non-Transparent Bridge (NTB) and copy data from the different BAR windows to destination memory regions.

Example 2 includes one or more later or earlier examples, wherein the data comprises key values and wherein the processors execute inference frameworks.

Example 3 includes one or more later or earlier examples, wherein the share data between the processors comprises: a first graphics processing unit (GPU) to read data from a first virtual memory region of the different memory regions and a second GPU to write data into a second virtual memory region of the different memory regions, wherein the first virtual memory region is associated with a first window of the BAR windows and the second virtual memory region is associated with a second window of the BAR windows.

Example 4 includes one or more later or earlier examples, wherein: the NTB is to operate in a manner consistent with Peripheral Component Interconnect Express (PCIe) and the NTB communicatively couples root complexes of the processors.

Example 5 includes one or more later or earlier examples, comprising instructions stored thereon, that if executed by at least one processor, cause the at least one processor to: based on unavailability of the NTB to share the data, select a network-based transport to share the data between the processors.

Example 6 includes one or more later or earlier examples, comprising instructions stored thereon, that if executed by at least one processor, cause the at least one processor to: based on a bandwidth of data sharing using NTB, enable compression of data shared between the processors.

Example 7 includes one or more later or earlier examples, comprising instructions stored thereon, that if executed by at least one processor, cause the at least one processor to: assign a process identifier to the windows to restrict accesses to the windows for data sharing.

Example 8 includes one or more later or earlier examples, wherein the processors comprise a prefill processor and a decode processor to perform large language model (LLM)-based inference operations.

Example 9 includes one or more later or earlier examples, and includes an apparatus comprising: a memory and a processor, to execute instructions stored in the memory, to: share data between processors by: allocation of different memory-mapped Base Address Register (BAR) windows associated with an Non-Transparent Bridge (NTB) to different memory regions, copy data from the different memory regions to the different BAR windows, and copy data from the different BAR windows to destination memory regions.

Example 10 includes one or more later or earlier examples, wherein the NTB is consistent with Peripheral Component Interconnect Express (PCIe) and the NTB communicatively couples root complexes of the processors.

Example 11 includes one or more later or earlier examples, wherein the share data between processors by writing to and reading from memory-mapped BAR windows comprises: a first graphics processing unit (GPU) reading data from a first virtual memory region while a second GPU concurrently writes per-token key value (KV) updates into a second virtual memory region, wherein the first virtual memory region is associated with a first window of the windows and the second virtual memory region is associated with a second window of the windows.

Example 12 includes one or more later or earlier examples, wherein the processor is to execute instructions stored in the memory, to: based on unavailability of the NTB to share the data, select a network-based transport to share the data between the processors.

Example 13 includes one or more later or earlier examples, wherein the processor is to execute instructions stored in the memory, to: based on a bandwidth of data sharing using NTB, enable compression of data shared between the processors.

Example 14 includes one or more later or earlier examples, wherein the processor is to execute instructions stored in the memory, to: assign a process identifier to the windows to restrict accesses to the windows for data sharing.

Example 15 includes one or more later or earlier examples, comprising a prefill processor and a decode processor, wherein: the prefill processor comprises one or more of: an accelerator, central processing unit (CPU), graphics processing unit (GPU), or core, the decode processor comprises one or more of: an accelerator, CPU, GPU, or core.

Example 16 includes one or more later or earlier examples, and includes a method that includes: sharing, by an Non-Transparent Bridge (NTB), key value (KV) data between a prefill processor and a decode processor to perform large language model (LLM)-based inference operations by writing to and reading from memory allocated to memory-mapped Base Address Register (BAR) windows.

Example 17 includes one or more later or earlier examples, and includes based on unavailability of the NTB to share the data, select a network-based transport to share the data between the processors.

Example 18 includes one or more later or earlier examples, and includes based on a bandwidth of data sharing using the NTB, causing compression of data shared between the processors.

Example 19 includes one or more later or earlier examples, and includes assigning a process identifier to the windows to restrict accesses to the windows for data sharing.

Example 20 includes one or more earlier examples, wherein the processors comprise a prefill processor and a decode processor to perform large language model (LLM)-based inference operations.

1. At least one computer-readable medium comprising instructions stored thereon, that if executed by at least one processor, cause the at least one processor to:
share data between processors by:
copy data from different memory regions to different Base Address Register (BAR) windows associated with a Non-Transparent Bridge (NTB) and copy data from the different BAR windows to destination memory regions.

2. The computer-readable medium of claim 1, wherein the data comprises key values and wherein the processors execute inference frameworks.

3. The computer-readable medium of claim 1, wherein the share data between the processors comprises:
a first graphics processing unit (GPU) to read data from a first virtual memory region of the different memory regions and a second GPU to write data into a second virtual memory region of the different memory regions, wherein the first virtual memory region is associated with a first window of the BAR windows and the second virtual memory region is associated with a second window of the BAR windows.

4. The computer-readable medium of claim 1, wherein:
the NTB is to operate in a manner consistent with Peripheral Component Interconnect Express (PCIe) and the NTB communicatively couples root complexes of the processors.

5. The computer-readable medium of claim 1, comprising instructions stored thereon, that if executed by at least one processor, cause the at least one processor to:
based on unavailability of the NTB to share the data, select a network-based transport to share the data between the processors.

6. The computer-readable medium of claim 1, comprising instructions stored thereon, that if executed by at least one processor, cause the at least one processor to:
based on a bandwidth of data sharing using NTB, enable compression of data shared between the processors.

7. The computer-readable medium of claim 1, comprising instructions stored thereon, that if executed by at least one processor, cause the at least one processor to:
assign a process identifier to the windows to restrict accesses to the windows for data sharing.

8. The computer-readable medium of claim 1, wherein the processors comprise a prefill processor and a decode processor to perform large language model (LLM)-based inference operations.

9. An apparatus comprising:
a memory and
a processor, to execute instructions stored in the memory, to:
share data between processors by:
allocation of different memory-mapped Base Address Register (BAR) windows associated with an Non-Transparent Bridge (NTB) to different memory regions,
copy data from the different memory regions to the different BAR windows, and
copy data from the different BAR windows to destination memory regions.

10. The apparatus of claim 9, wherein the NTB is consistent with Peripheral Component Interconnect Express (PCIe) and the NTB communicatively couples root complexes of the processors.

11. The apparatus of claim 9, wherein the share data between processors by writing to and reading from memory-mapped BAR windows comprises:
a first graphics processing unit (GPU) reading data from a first virtual memory region while a second GPU concurrently writes per-token key value (KV) updates into a second virtual memory region, wherein the first virtual memory region is associated with a first window of the windows and the second virtual memory region is associated with a second window of the windows.

12. The apparatus of claim 9, wherein the processor is to execute instructions stored in the memory, to:
based on unavailability of the NTB to share the data, select a network-based transport to share the data between the processors.

13. The apparatus of claim 9, wherein the processor is to execute instructions stored in the memory, to:
based on a bandwidth of data sharing using NTB, enable compression of data shared between the processors.

14. The apparatus of claim 9, wherein the processor is to execute instructions stored in the memory, to:
assign a process identifier to the windows to restrict accesses to the windows for data sharing.

15. The apparatus of claim 9 comprising a prefill processor and a decode processor, wherein:
the prefill processor comprises one or more of: an accelerator, central processing unit (CPU), graphics processing unit (GPU), or core and the decode processor comprises one or more of: an accelerator, CPU, GPU, or core.

16. A method comprising:
sharing, by an Non-Transparent Bridge (NTB), key value (KV) data between a prefill processor and a decode processor to perform large language model (LLM)-based inference operations by writing to and reading from memory allocated to memory-mapped Base Address Register (BAR) windows.

17. The method of claim 16, comprising:
based on unavailability of the NTB to share the data, select a network-based transport to share the data between the processors.

18. The method of claim 16, comprising:
based on a bandwidth of data sharing using the NTB, causing compression of data shared between the processors.

19. The method of claim 16, comprising:
assigning a process identifier to the windows to restrict accesses to the windows for data sharing.

20. The method of claim 16, wherein the processors comprise a prefill processor and a decode processor to perform large language model (LLM)-based inference operations.
